(19) United States
(12) Patent Application Publication
(10) Pub. No.: US 2007/0221061 A1
(43) Pub. Date: Sep. 27, 2007

(54) Air purifier

(75) Inventors: Mark C. Steiner, Richmond, VA (US); Guoyao Ye, Richmond, VA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Hamilton Beach/Proctor-Silex, Inc.

(21) Appl. No.: 11/372,792

(22) Filed: Mar. 10, 2006

(51) Int. Cl. B03C 3/00; B01D 46/00

(52) U.S. Cl. 96/63; 55/467

(57) ABSTRACT

An air purifier for removing particles from air and providing an aesthetically pleasing appearance includes a housing having an air inlet, an air outlet and an airflow path therethrough. An air filter is mounted within the housing in the airflow path and a motor is mounted within the housing. The motor includes a motor shaft and a fan is mounted to the motor shaft for urging air into the air inlet, through the airflow path and out of the air outlet. An air cowl is removably mounted to the housing. The air cowl includes a peripheral edge. The air inlet or the air outlet is defined between the peripheral edge and the housing. A method of operating the air purifier with the inlet or outlet formed between the peripheral edge and the housing is also disclosed.

### BACKGROUND OF THE INVENTION

The present application is directed to an air purifier for removing particles from air. The air purifier preferably removes dust and other particles from a room, typically in a household environment. More particularly, the present application is directed to an air purifier that provides an aesthetically pleasing appearance and removes the particles from air in the room.

As room air and the atmosphere in general becomes contaminated, dusty or otherwise dirtied, the general population becomes aware of discomforts and other disadvantages associated with contaminated air. Air purification and/or filtration devices of various shapes, sizes and capacities have become more popular as a result of the increased awareness of household air quality and air quality in general. Various air purifiers or air filtration devices are available for home or industrial use but are often unsightly.

It would be desirable to construct an air purifier that removes particles, including dust, from air and provides an aesthetically pleasing appearance. It would also be desirable to construct an air purifier that has an aesthetically pleasing appearance that is adaptable to user preferences and includes an air filter that may be removed and replaced with a replacement filter or is otherwise cleanable to increase the useful life of the air filter.

### BRIEF SUMMARY OF THE INVENTION

Briefly stated, a preferred embodiment of the present invention is directed to an air purifier for removing particles from air and providing an aesthetically pleasing appearance. A housing includes an air inlet, an air outlet and an airflow path therethrough. An air filter is mounted within the housing in the airflow path and a motor is mounted within the housing. The motor includes a motor shaft and a fan is mounted to the motor shaft for urging air into the air inlet, through the airflow path and out of the air outlet. An air cowl is removably mounted to the housing and includes a peripheral edge. The air inlet or the air outlet is defined between the peripheral edge of the air cowl and the housing.

In another aspect, a preferred embodiment of the present application is directed to a method of operating an air purifier including a housing having an airflow path therethrough and an air outlet. A motor is mounted within the housing and a fan is positioned within the airflow path driven by the motor. An air filter is positioned within the airflow path and an air cowl having a peripheral edge and a decorative pattern is mounted to the housing. An air inlet is defined between the peripheral edge of the air cowl and the housing. The method includes the steps of mounting the air cowl to the housing such that the peripheral edge defines the air inlet with the housing, positioning the air purifier within a room and actuating the motor to drive the fan and urge the air into the air inlet, through the air filter and out of the air outlet.

### BRIEF DESCRIPTION OF THE SEVERAL VIEWS OF THE DRAWINGS

The foregoing summary, as well as the following detailed description of a preferred embodiment of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown. In the drawings:

FIG. 1 is a top perspective view of a preferred embodiment of the air purifier of the present invention;

FIG. 2 is a side perspective, partially exploded view of the air purifier shown in FIG. 1;

FIG. 3 is a cross-sectional view of the air purifier shown in FIG. 1, taken along line 3-3 of FIG. 1;

FIG. 4 is a left-side elevational view of the air purifier shown in FIG. 1;

FIG. 5 is a top plan view of the air purifier shown in FIG. 1;

FIG. 6 is a rear perspective view of a pair of scrolls, a pair of fans and a motor of the air purifier shown in FIG. 1, with portions of the air purifier hidden for clarity; and

FIG. 7 is a schematic block diagram of a controller and related components of the air purifier shown in FIG. 1.

### DETAILED DESCRIPTION OF THE INVENTION

Certain terminology is used in the following description for convenience only and is not limiting. The words, “right”, “left”, “lower”, “inwardly”, “outwardly” and “upper” designate directions toward and away from, respectively, the geometric center of the air purifier and designated parts thereof. The words “up”, “down”, “right” and “left” designate directions in the drawings that correspond to the orientation of the preferred air purifier and designated parts thereof, but are not limiting. The terminology includes the above-listed words, derivatives thereof and words of similar import.

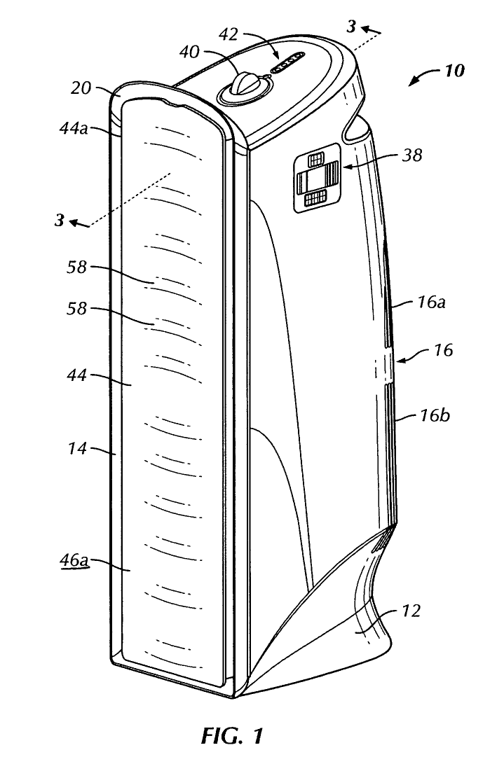

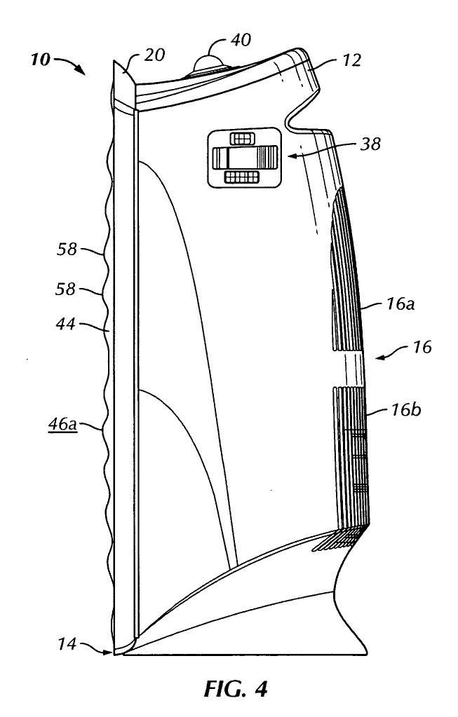

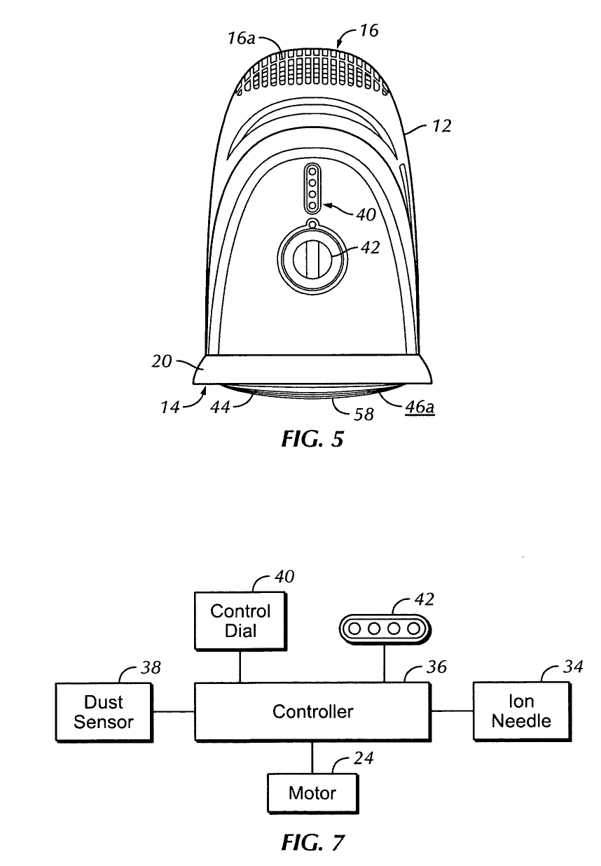

Referring to the drawings wherein like numerals indicate like elements throughout, there is shown in FIGS. 1-5 a preferred embodiment of an air purifier, generally designated 10, for removing particles from air and providing an aesthetically pleasing appearance.

Referring to FIGS. 1-4, the air purifier 10 includes a housing 12 having an air inlet 14, an air outlet 16 and an airflow path therethrough. In the preferred embodiment, the housing 12 is constructed of a molded, generally rigid polymeric material that is generally hollow between the air inlet 14 and the air outlet 16 to form the airflow path therethrough. The housing 12 is not limited to being constructed of generally rigid, molded polymeric materials and may be constructed of nearly any material that is able to take on the general shape of the housing 10 and withstand the normal operating conditions of the housing. For example, the housing 12 may be constructed of a formed sheet metal, assembled wooden or machined metal housing with an air inlet, an air outlet and an airflow path therethrough.

In the preferred embodiment, the air outlet 16 is comprised of a first louvered vent 16a and a second louvered vent 16b integrally molded into a rear surface of the housing 12. The louvers of the first and second louvered vents 16a, 16b permit airflow through the air outlet 16 and generally prevent insertion of objects or appendages of a user's body into the outlet 16 and potentially into contact with moving parts of the air purifier 10 within the housing 12. The air purifier 10 is not limited to including the first and second louvered vents 16a, 16b to form the air outlet 16 and the air outlet 16 may be comprised of nearly any penetration, hole or air permeable surface on the housing 12 that permits airflow out of the housing 12 from the airflow path. For example, the air outlet 16 may be comprised of a hole in the housing 12, the hole being covered by an air permeable sheet or a plurality of holes in the housing 12 that permit flow of air out of the housing 12.

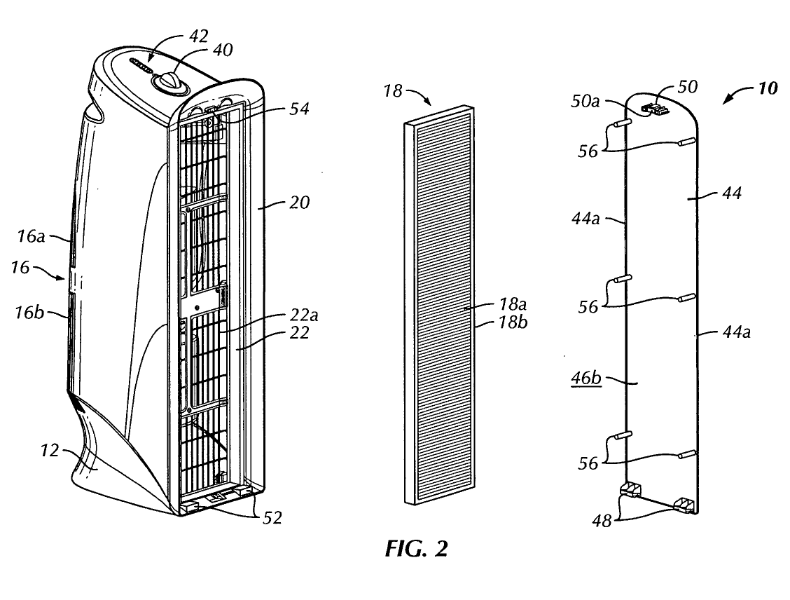

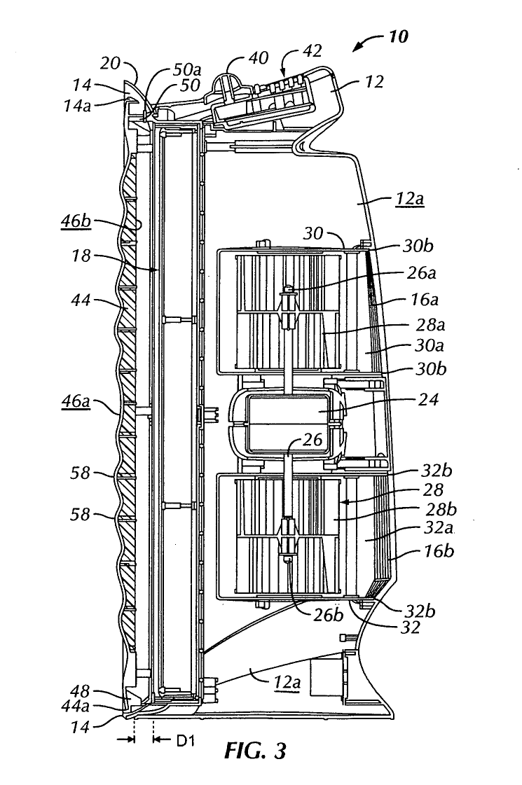

Referring to FIGS. 2 and 3, the air purifier 10 also includes an air filter 18 mounted within the housing 12 in the airflow path. In the preferred embodiment, the air filter 18 is comprised of a filter frame 18b that supports a pleated filter material 18a at its periphery. The air filter 18 preferably has a generally rectangular shape or configuration and is mounted within the airflow path in the housing 12 such that a large majority or all of the air that flows through the airflow path in the housing 12 flows through the filter material 18a for purification or removal of dust, particles or other contaminants from the air prior to flowing out of the housing 12 through the air outlet 16. The filter material 18a may be comprised of nearly any type or variety of filter including but not limited to a fibrous filter material, a carbon filter or a high efficiency particulate absorbing/high efficiency particulate air (HEPA) filter material. In addition, the air filter 18 is not limited to being comprised of the filter material 18a mounted within the filter frame 18b and may be comprised of a piece of filter material that is mountable within the airflow path to permit air flow therethrough and capture particles, dust or other contaminants.

Referring to FIGS. 1-5, in the preferred embodiment, the housing 12 includes an arcuate-shaped inlet cowl 20 and a filter box 22 mounted to a front of the housing 12. The filter box 22 preferably includes an airflow grate 22a that extends into and across the airflow path and permits airflow therethrough. The filter box 22, airflow grate 22a and arcuate-shaped inlet cowl 20 are preferably constructed of a generally rigid, molded polymeric material that is fixed or secured to a front of the housing 12 and forms a portion of the housing 12 proximate the air inlet 14. The inlet cowl 20, filter box 22 and airflow grate 22a are not limited to being constructed of a generally rigid, polymeric material and may be constructed of nearly any rigid, structural material that is able to take on the general shape of the inlet cowl 20, filter box 22 and airflow grate 22a and perform the typical functions of these components. In addition, the inlet cowl 20, filter box 22 and airflow grate 22a may be integrally molded with the housing 12.

The preferred filter box 22 permits mounting of the air filter 18 therein and aids in the proper alignment of the air filter 18 within the housing 12 in the airflow path. In addition, the arcuate-shape of the inlet cowl 20 of the preferred air purifier 10 guides or funnels air from the room into the air inlet 14 and into the airflow path during use of the air purifier 10. Further, the airflow grate 22a aids in properly positioning the air filter 18 within the airflow path in the housing 12 and securing the air filter 18 in a preferred location in the airflow path. The air purifier 10 is not limited to inclusion of the single-piece inlet cowl 20, filter box 22 and airflow grate 22a and these components may be separately or alternately constructed or not included in the air purifier 10 without significantly impacting the operation of the air purifier 10. However, the inlet cowl 20 is preferred for guiding the flow of air into the air inlet 14 and the filter box 22 and airflow grate 22a are preferred for aiding in positioning of the air filter 18 in a preferred location in the airflow path and securing the air filter 18 within the housing 12 in a preferred location.

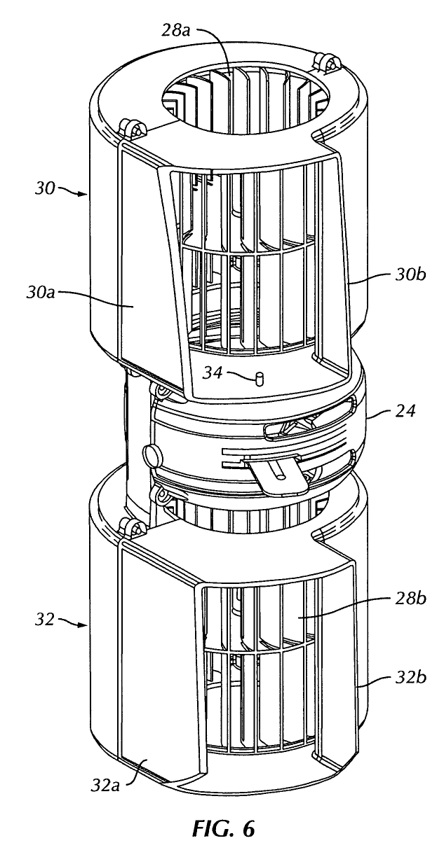

Referring to FIGS. 3 and 6, the air purifier 10 also includes a motor 24 mounted within the housing 12. The motor 24 includes a motor output shaft 26. In the preferred embodiment, the motor 24 is comprised of an electric motor and the motor output shaft 26 extends from two ends or a top and bottom end of the motor 24. The air purifier 10 is not limited to inclusion of an electric motor 24 and may include a battery operated motor or other drive mechanism that is able to provide power to draw air into the air inlet 14, through the airflow path and out of the air outlet 16 of the housing 12.

A fan 28 is mounted to the motor shaft 26 for urging air into the air inlet 14, through the airflow path and out of the air outlet 16. In the preferred embodiment, a first scroll 30 is mounted within an upper portion of the housing 12 in the airflow path and a second scroll 32 is mounted within a lower portion of the housing 12 in the airflow path. In addition, the motor output shaft 26 preferably includes a first end 26a and a second end 26b. The fan 28 preferably includes a first fan 28a and a second fan 28b secured to the first motor shaft end 26a within the first scroll 30 and to the second motor shaft end 26b in the second scroll 32, respectively. Accordingly, in the preferred embodiment, the motor 24 drives the motor shaft 26 with the first and second fans 28a, 28b mounted to the first and second motor shaft ends 26a, 26b to draw air into the air inlet 14 and expel air from the housing 12 through the air outlet 16. The first and second fans 28a, 28b are preferably mounted within the scroll housings 30, 32 to improve the effectiveness of the fans 28a, 28b and the flow of air through the airflow path. The air purifier 10 is not limited to inclusion of the first and second fans 28a, 28b mounted to the first and second ends 26a, 26b of the motor shaft 26 within the first and second scrolls 30, 32 and may be comprised of a single fan that draws air into the air inlet 14, through the air filter 18, airflow path and out of the air outlet 16. In addition, the air purifier 10 may include a plurality of motors that drive a plurality of fans to urge air flow through the housing 12 along the airflow path. In the preferred embodiment, the first and second fans 28a, 28b are comprised of basket-like fans, which are described in U.S. reference. The basket-like fans are generally well known to those having ordinary skill in the art and will not be described in further detail.

In the preferred embodiment, the first scroll 30 includes a first outlet chute 30a and the second scroll 32 includes a second outlet chute 32a. The first and second outlet chutes 30a, 32a preferably include first and second terminal edges 30b, 32b, respectively, that are positioned proximate an inner surface 12a of the housing 12 proximate the first louvered vent 16a and the second louvered vent 16b, respectively, to direct air out of the air outlet 16. Preferably, the first and second terminal edges 30b, 32b of the first and second outlet chutes 30a, 32a are in facing engagement with the inner surface 12a of the housing 12 at a periphery of the first and second louvered vents 16a, 16b to channel or urge air directly out of the first and second louvered vents 16a, 16b. The scrolls 30, 32 are not limited to inclusion of the first and second outlet chutes 30a, 32a or to the first and second terminal edges 30b, 32b being in facing engagement with the inner surface 12a at a periphery of the first and second louvered vents 16a, 16b. For example, the scrolls 30, 32 may include outlets that are spaced from the air outlet 16 or the first and second scrolls 30, 32 and may be constructed such that they do not include the first and second outlet chutes 30a, 32a, respectively. However, it is preferred that the first and second terminal edges 30b, 32b of the first and second outlet chutes 30a, 32a are in facing engagement with the inner surface 12a proximate a peripheral edge of the first and second louvered vents 16a, 16b to urge air directly out of the air outlet 16 from the housing 12 to improve airflow through the airflow path.

Referring to FIGS. 3 and 6, in the preferred embodiment, one or more ionizer needles 34 are secured and positioned in the first and/or second outlet chutes 30a, 32a. The ionizer needle 34 is preferably comprised of an electrically charged carbon fiber brush 34 that provides an electrical charge to particles that flow through one or both of the first and second outlet chutes 30a, 32a. The air purifier 10 is not limited to inclusion of the charged carbon fiber brush 34 or to inclusion of a single ionizer needle 34 positioned in the first outlet chute 30a, as is shown in FIGS. 3 and 6. The air purifier 10 may be constructed without inclusion of the ionizer needle 34 or may include a plurality of ionizer needles (not shown) mounted within the airflow path to charge particles that proceed along the airflow path. However, the charged carbon fiber brush 34 is preferably mounted at least to the first outlet chute 30a to charge particles as they flow out of the first louvered vent 16a such that the particles are attracted to an oppositely charged object and generally do not remain suspended in the air or the room. The ionizer needle or charged carbon fiber brush 34 is generally well known to those having ordinary skill in the art and is not described in greater detail.

Referring to FIGS. 1-7, in the preferred embodiment, a controller 36 is secured to the housing 12 and is in communication with the motor 24. A dust sensor 38 is preferably secured to the housing 12 and is in communication with the controller 36. The dust sensor 38 preferably sends dust readings to the controller 36 and the controller 36 actuates the motor 24 to operate at one of a plurality of operating speeds based upon the dust readings when the air purifier 10 is operating in an automatic mode. The air purifier 10 is not limited to inclusion of the controller 36 or the dust sensor 38 and may be constructed without inclusion of either of these components without significantly impacting the overall operation of the air purifier 10.

In the preferred embodiment, the dust sensor 38 is comprised of a Particulate Matter Sensor, Model No. PPD4NS, sold by Shinyei Kaisha Electronic Instruments Division. The dust sensor 38 is preferably an optical sensor that senses particulates in the air and sends a signal to the controller 36 related to the optically measured particulate matter, dust or other contaminants suspended in the air of the room. The dust sensor 38 is not limited to the above-described particulate matter sensor and may be comprised of nearly any sensor that is able to sense particulates, dust or other contaminants in air and convey a signal to the controller 36 related to the amount of particulate, dust or other contaminant in the air.

In the preferred embodiment, a control dial 40 is in communication with the controller 36 and is actuatable between automatic, low or whisper clean, medium and high or quick clean operating modes of the air purifier 10. In addition, an array of indicator lights 42 is preferably mounted to an external surface of the housing 12. The array of indicator lights 42 are preferably also in communication with the controller 36 and provide a visual indication of the dust readings from the dust sensor 38 and an indication of whether the air purifier 10 is powered. The control dial 40 and array of indicator lights 42 are preferably mounted and secured to a top surface of the housing 12 of the air purifier 10 for ease of access by a user and relatively simple visual locating of the control dial 40 and array of indicator lights 42. The control dial 40 and array of indicator lights 42 are not limited to inclusion in the air purifier 10 or to mounting at the top surface of the housing 12. For example, the control dial 40 and array of indicator lights 42 may be eliminated from the air purifier 10 without significantly impacting the operation of the air purifier 10 or may be adapted for other specific uses of the air purifier 10. However, the control dial 40 is preferably included for selection of various operating modes of the air purifier 10 and the array of indicator lights 42 are preferably mounted to the housing 12 for providing an indication to a user of the dust signal or amounts of particulates, contaminants or dust suspended in the air proximate the air purifier 10 and an indication of whether the air purifier 10 is powered.

In the preferred embodiment, the control dial 40 is actuable between the above-listed automatic, low, medium and high operating modes of the air purifier 10. The air purifier 10 is powered and the controller 36 preferably illuminates at least one of the array of indicator lights 42. In the automatic mode, the air purifier 10 samples the particulates or dust in the air using the dust sensor 38, the dust sensor 38 sends a signal to the controller 36 and based upon the signal, the controller 36 actuates the motor 24 to operate at a determined speed. For example, if the dust signal indicates a relatively high amount of particulates or dust in the air, the controller 36 may actuate the motor 24 to operate at a high speed such that a relatively large volume of air is drawn through the air filter 18 to purify or condition a relatively large volume of air in a short amount of time. Conversely, if the dust reading indicates a relatively low amount of particulate or dust in the air, the controller 36 may actuate the motor 24 to operate at a relatively slow speed to urge a lower volume of air through the air filter 18, in comparison to the same amount of time that the relatively large amount of air flows through the air filter 18 when the motor 24 is operated at the high speed. In addition, the array of indicator lights 42 provides a visual indication to the user regarding the amount of particles or dust that are sensed in the air based upon the dust readings from the dust sensor 38. For example, if a large or relatively large dust reading is transmitted to the controller 36 from the dust sensor 38, the controller 38 may illuminate each of the array of indicator lights 42 associated with the dust sensor 38, while one or none of the array of indicator lights 42 is illuminated if the dust reading is relatively low. The array of indicator lights 42 may include nearly any number of individual indicator lights, however, in the preferred embodiment, the array of indicator lights 42 includes four individual lights.

Referring to FIGS. 1-5, the air purifier 10 includes an air cowl 44 removably mounted to the housing 12. The air cowl 44 includes a peripheral edge 44a and the air inlet 14 or air outlet 16 is defined between the peripheral edge 44a and the housing 12. In the preferred embodiment, the air cowl 44 is constructed of a generally planar, rigid, polymeric panel and has a generally rectangular-shape. The air cowl 44 is not limited to constructions including a general rectangular-shape, being generally planar or to being constructed of a molded, polymeric material. The air cowl 44 may be constructed of nearly any generally rigid, structural material that is able to take on the general shape of the air cowl 44 and withstand the normal operating conditions of the air cowl 44. For example, the air cowl 44 may be constructed of a sheet metal, wooden or other like material that is able to take on the general shape of the air cowl 44 and withstand the normal operating conditions of the air cowl 44.

In the preferred embodiment, the air cowl 44 has an exposed face 46a and an internal face 46b. In the preferred embodiment, a pair of alignment arms 48, generally having a hook-like-shape extend generally perpendicularly from the internal face 46b proximate a lower portion of the peripheral edge 44a and an engagement arm 50 extends generally perpendicularly from the internal face 46b proximate an upper portion of the peripheral edge 44a of the air cowl 44. The air cowl 44 is not limited to inclusion of the pair of alignment arms 48 having the hook-shape or to the engagement arm 50 extending generally perpendicularly from the internal face 46b proximate the top peripheral edge 44a. However, the air cowl 44 preferably includes the pair of alignment arms 48 and the engagement arm 50 to mount the air cowl 44 to the housing 12 in a removable manner, as will be described in greater detail below.

Referring to FIG. 2, in the preferred embodiment, the inlet cowl 20 includes a pair of alignment indentations 52 proximate a lower portion and a first magnetic member 54 mounted to an upper portion. The alignment indentations 52 are preferably comprised of a pair of cavities molded into the inlet cowl 20 at a downstream portion of the inlet cowl 20 and the first magnetic member 54 is preferably comprised of a magnet mounted to the inlet cowl 20 proximate an upper, downstream portion of the inlet cowl 20. To engage the air cowl 44 with the housing 12, the alignment arms 48 are inserted into the alignment indentations 52 to properly align the air cowl 44 with the housing 12 and inlet cowl 20 and the lower peripheral edge 44a of the air cowl 40 is pivoted about the alignment arms 48 and alignment indentations 52 such that the engagement arm 50 moves toward the first magnetic member 54. When the first magnetic member 54 contacts the engagement arm 50 or a magnetic plate 50a mounted to the engagement arm 50, the air cowl 44 is secured in position relative to the housing 12, the inlet cowl 20 and the filter box 22, as shown in FIG. 1. The air cowl 44 is not limited to inclusion of the alignment arms 48, the engagement arm 50 and the magnetic plate 50a and the housing 12 or the air cowl 20 are not limited to inclusion of the alignment indentations 52 and the first magnetic member 54 that cooperate to removably mount the air cowl 44 to the housing 12. The air cowl 44 may be alternately removably mounted to the housing 12, for example, by clamping, adhesively bonding, utilization of hook and loop material or otherwise removably mounting the air cowl 44 to the housing 12, as would be understood by one having ordinary skill in the art. However, the combination of the alignment arms 48, engagement arm 50 and magnetic plate 50a of the air cowl 44 and the alignment indentations 52 and first magnetic member 54 of the inlet cowl 20, which combine to removably mount the air cowl 44 to the housing 12 is preferred for its relative simplicity and ability to properly mount the air cowl 44 to the housing 12.

The air cowl 44 also preferably includes a plurality of spacers 56 extending generally perpendicularly from the internal face 56b proximate the peripheral edge 44a. The spacers 56 are preferably integrally molded with the air cowl 44 and have a generally cylindrical-shape. The spacers 56 are not limited to extended generally perpendicularly from the internal face 46, to being integrally molded with the air cowl 44 or to having a generally cylindrical-shape. For example, the plurality of spacers 56 may be separately mounted rubber or polymeric blocks having a generally square or rectangular shape and mounted to the internal face 46 or may be mounted to the air cowl 20 or the air filter 18. However, the spacers 56 are preferably integrally molded, have a generally cylindrical-shape and extend generally perpendicularly from the internal face 46b to perform the function of the spacers 56 as will be described in greater detail below.

In a preferred assembled configuration, the spacers 56 locate the internal face 46a a first distance D1 from an upstream-face of the air filter 18. In the preferred embodiment, the first distance D1 is approximately X inches (X″) but is not so limited. The first distance D1 may comprise nearly any value that creates a space between the internal face 46b and the upstream face of the filter 18 such that air is able to flow between the internal face 46b and the air filter 18 and the air is able to flow into the entire upstream-face of the air filter 18. The spacers 56 preferably provide a consistent first distance D1 between the internal face 46b and the upstream-face of the air filter 16 such that the air purifier 10 consistently filters or purifies air in operation. The internal face 46b is also not limited to being generally planar and may be sloped and/or curved to direct airflow from the inlet 14 toward the air filter 18 depending upon the configuration of the air purifier 10, as will be understood by one having ordinary skill in the art. For example, the internal face 46b may be curved to channel or funnel air toward a specific portion of the air filter 18 or the air purifier 10 may include multiple separate air filters (not shown) that are mounted in the housing 12 with air flow channeled into the separate air filters by channeling features constructed on the internal face 46b.

Referring to FIGS. 1 and 3-5, in the preferred embodiment, the exposed face 46a of the air cowl 44 includes a decorative pattern integrally molded thereon. In the most preferred embodiment, the decorative pattern is comprised of a series of wavy-shaped ribs 58 extending from the exposed surface 46a. The wavy ribs 58 provide a generally aesthetically pleasing exposed face 46a for the air purifier 10 that is generally preferred by a user. The exposed face 46a may also include printing on the face to provide additional aesthetically pleasing designs or may be variably colored to otherwise visually adapt to user preferences. The exposed face 46a is not limited to inclusion of the wavy ribs 58 and may include a flat or completely planar exposed face 46a that may be drawn or printed upon by a user or may accept a photo, rendering or other aesthetically pleasing panel subject to user preferences. The exposed face 46a may also be otherwise adapted for user preferences including integrally molded sculptures thereon or alternate aesthetically pleasing renderings or drawings that are adapted for user preferences.

Referring to FIGS. 1-7, in operation, the inlet cowl 20 and filter box 22 are secured to the housing 12 to form an inlet portion of the housing 12 and the air filter 18 is positioned within the filter box 22 such that a lower edge of the air filter 18 rests upon a lower surface of the filter box 22. In this position, a downstream-face of the air filter 18 is positioned proximate or in facing engagement with the airflow grate 22a. The air cowl 44 is then mounted to the housing 12 by engaging the alignment arms 48 with the alignment indentations 52 and pivoting the air cowl 44 about the alignment arms 48 and the alignment indentations 52 such that the upper peripheral edge is positioned proximate an upper portion of the inlet cowl 20. The air cowl 44 is pivoted until the magnetic plate 50a mounted to the engagement arm 50 comes into contact with the first magnetic member 54 mounted to the inlet cowl 20 to secure the air cowl 44 to the inlet cowl 20, filter box 22 and housing 12. In the assembled configuration, the spacers 56 are positioned proximate or in facing engagement with the upstream-face of the air filter 18 to secure the air filter 18 in position in the airflow path. In this position, the air filter 18 preferably is positioned in the filter box 22 such that a peripheral surface of the filter frame 18b is in facing engagement with the filter box 22 and nearly no air is able to flow between the filter frame 18b and the filter box 22. The air filter 18 may also be sized such that the filter frame 18b is force-fit into the filter box 22 such that the area between the air filter 18 and the filter box 22 is nearly air impermeable. The spacers 56 create the airflow space between the internal face 46b and the upstream-face of the air filter 18 and the first distance D1 between the internal face 46b and the upstream-face of the air filter 18 to promote airflow therein.

When the air purifier 10 is in the assembled configuration, the air purifier 10 is positioned within a room and the motor 24 is actuated to drive the first and second fans 28a, 28b to urge air from the room into the air inlet 14, through the air filter 18, specifically through the filter material 18a, and out of the first and second louvered vents 16a, 16b. Specifically, the user manipulates the control dial 40 to place the air purifier 10 in one of the automatic, low or whisper clean, medium and high or quick clean modes. When one of the modes is selected and the motor 24 is actuated to begin rotation of the first and second fans 28a, 28b, air is drawn into the air inlet 14. Specifically, air is drawn into the air inlet 14, defined between the peripheral edge 44a of the air cowl 44 and the inlet cowl 20. Defining the air inlet 14 between the peripheral edge 44a and the inlet cowl 20 permits construction of the air cowl 44 with the relatively large, continuous exposed face 46a that may include the decorative pattern thereon including the wavy ribs 58. The relatively large, continuous, uninterrupted exposed face 46a provides many options for a user to include an aesthetically pleasing photo, sculpture or alternative aesthetically pleasing design configuration on the exposed face 46a. Such a relatively large, continuous exposed face 46a is relatively uncommon in air purifiers as inlets 14 and outlets 16 of typical air purifiers are generally comprised of louvered vents or holes in a housing that are generally not adaptable for aesthetically pleasing designs or configurations.

If the whisper clean or low mode is selected, the controller 36 actuates the motor 24 to operate at a relatively low speed to rotate the motor shaft 26 and first and second fans 28a, 28b at a relatively low speed. Such a relatively low speed rotation of the motor shaft 26 and first and second fans 28a, 28b permits the air purifier 10 to operate at a relatively low noise level. As the first and second fans 28a, 28b begin to rotate, air is drawn through the air inlet 14 between the peripheral edge 44a and the inlet cowl 20, into the space between the internal face 46b and the upstream-face of the air filter 18 created by the first distance D1, through the air filter 18 and into an area within the housing 12 proximate the first and second scrolls 30, 32. The air is then drawn into either upper or lower open ends of the first and second scrolls 30, 32, flows past the basket-like first and second fans 28a, 28b, into the first and second outlet chutes 30a, 32a and out of the first and second louvered vents 16a, 16b. In operation, the outlet air preferably flows past the ionizer needle 34, charging the particles remaining in the initially filtered air with an electrical charge such that the particles are attracted to a surface or to each other and generally do not remain suspended within the air. In the medium and quick clean or high modes, the air purifier 10 operates in nearly an identical manner to the whisper clean or low mode with the motor 24 actuated by the controller 36 to operate at a medium or high speed, respectively, and draw an a larger volume of air into the air purifier 10 when compared to operation in the low or whisper clean mode.

When the user selects operation in the automatic mode, the dust sensor 38 senses a dust reading, comprised of a level of dust, particles or other contaminants in the air, and transmits the dust reading to the controller 36. The controller 36 illuminates the array of indicator lights 42 to provide a visual indication to the user of the level of particulates or dust in the air proximate the air purifier 10. In addition, based upon the dust readings, the controller 36 actuates the motor 24 to operate at one of the low, medium or high speeds. For example, if the dust reading is relatively low, the controller 36 actuates the motor 24 to operate at the low speed and if the dust reading is relatively high, the controller 36 actuates the motor 24 to operate at the high speed. In addition, the dust sensor 38 continuously senses the level of particulates, contaminants or dust in the air proximate the air purifier 10, transmits the dust readings to the controller 36 and the controller 36 preferably, automatically modifies the operating speed of the motor 24 based upon the changing dust readings. Further, the controller 36 modifies the visual indication of the array of indicators 42 to correspond to the dust readings as the dust readings change.

In the preferred operation of the air purifier 10, the ionizer needle 34 is constantly emitting a charge to particles and air in or proximate to the air outlet 16. The controller 36 is not limited to constantly powering the ionizer needle 34 and may selectively power or charge the ionizer needle 34 based upon the dust readings or the mode of operation selected by the user, as will be understood by one having ordinary skill in the art.

Referring to FIGS. 1-7, in the preferred embodiment, the airflow through the airflow channel of the air purifier 10 enters through the air inlet 14 between the peripheral edge 44a and the inlet cowl 20, flows into the space between the upstream face of the air filter 18 and the internal face 46a of the air cowl 44, flows through the air filter 18 where particles, dust or other contaminants are captured in the filter material 18a, into the space in the housing 12 proximate the first and second scrolls 32, 34, into the scrolls 30, 32 through upper or lower openings, past the first and second fans 28a, through the first and second outlet chutes 30a, 30b and out of the first and second louvered vents 16a, 16b. The air purifier 10 is not limited to the described airflow pattern and the airflow may alternately flow through the air purifier 10. For example, the air inlet 14 between the peripheral edge 44a and the inlet cowl 20 may be configured as an air outlet such that the decorative exposed face 46a of the air cowl 44 is located the outlet of the air purifier 10, as would be understood by one having ordinary skill in the art.

To replace or clean the air filter 18 of the air purifier 10, the air cowl 44 is removed by pivoting the upper peripheral edge 44a away from the inlet cowl 20 such that the magnetic plate 50a is disengaged from the first magnetic number 54. The air cowl 44 preferably pivots about the alignment arms 48 and the alignment indentation 52 and the user removes the air cowl 44 from engagement with the housing 12. If the air filter 18 is fixed, force-fit or permanently secured in the filter box 22 or housing 12, a user may clean the upstream-face of the air filter 18 using a vacuum or other cleaning methods. If the air filter 18 is disposable and removable from the filter box 22 or housing 12, the user grasps the air filter 18, removes the air filter 18 from the filter box 22 and inserts a replacement filter 18 into the filter box 22. The contaminated or dirty air filter 18 may be disposed of or may be cleaned for subsequent use. The air cowl 44 is then mounted to the housing 12 to secure the replacement air filter 18 in the filter box 22. When the motor 24 is actuated to draw air into the air inlet 14, the removable and replaceable air filter 18 is generally drawn into facing engagement with the airflow grate 22 to secure the air filter 18 in the airflow path.

It will be appreciated by those skilled in the art that changes could be made to the embodiment described above without departing from the broad inventive concept thereof. It is understood, therefore, that this invention is not limited to the particular embodiment disclosed, but it is intended to cover modifications within the spirit and scope of the present invention, as defined by the appended claims.

We claim:

1. An air purifier for removing particles from air and providing an aesthetically pleasing appearance, the air purifier comprising:
a housing including an air inlet, an air outlet and an air flow path therethrough;
an air filter mounted within the housing in the air flow path;
a motor mounted within the housing including a motor shaft;
a fan mounted to the motor shaft for urging air into the air inlet, through the air flow path and out of the air outlet;
an air cowl removably mounted to the housing, the air cowl including a peripheral edge, one of the air inlet and the air outlet being defined between the peripheral edge and the housing.

2. The air purifier of claim 1 wherein the air cowl is generally planar and has a generally rectangular-shape, the air cowl having an exposed face and an internal face, at least one alignment arm and at least one engagement arm extending generally perpendicularly from the interior face.

3. The air purifier of claim 1 wherein the housing includes an arcuate-shaped inlet cowl, the air inlet being defined between the peripheral edge and the inlet cowl.

4. The air purifier of claim 3 wherein the inlet cowl includes a least one alignment indentation and a first magnetic member

5. The air purifier of claim 1 wherein the air cowl includes an exposed face and an internal face, a plurality of spacers extending generally perpendicularly from the internal face, the spacers locating the internal face a first distance from the air filter in an assembled configuration.

6. The air purifier of claim 1 wherein the air cowl is constructed of a molded, polymeric material, the air cowl including an exposed face and an internal face, the exposed face including a decorative pattern integrally located thereon.

7. The air purifier of claim 6 wherein the decorative pattern is comprised of a series of wavy-shaped ribs extending from the exposed face.

8. The air purifier of claim 1 wherein the housing includes an arcuate-shaped inlet cowl and a filter box, the filter box including an air flow grate, the air filter secured in the filter box between the air cowl and the air flow grate.

9. The air purifier of claim 1 further comprising:
a first scroll mounted within the housing in the air flow path; and
a second scroll mounted within the housing in the air flow path, the motor shaft including a first end and a second end, the fan comprised of a first fan and a second fan, the first fan secured to the first end within the first scroll and the second fan secured to the second end within the second scroll.

10. The air purifier of claim 9 wherein the air outlet is comprised of a first louvered vent and a second louvered vent formed in the housing, the first scroll including a first outlet chute and the second scroll including a second outlet chute, the first outlet chute and the second outlet chute including first and second terminal edges, respectively, the first terminal edge being positioned proximate an inner surface of the housing proximate the first louvered vent and the second terminal edge being positioned proximate the inner surface of the housing proximate the second louvered vent to direct air out of the air outlet.

11. The air purifier of claim 9 further comprising:
an ionizer needle positioned in at least one of the first outlet chute and the second outlet chute.

12. The air purifier of claim 1 further comprising:
a controller secured to the housing and being in communication with the motor; and
a dust sensor secured to the housing and in being in communication with the controller, the dust sensor sending dust readings to the controller, the controller actuating the motor to operate at one of a plurality of operating speeds based upon the dust readings.

13. The air purifier of claim 12 further comprising:
a control dial in communication with the controller, the control dial actuable between automatic, low, medium and high modes; and
an array of indicator lights mounted to an external surface of the housing, the array of indicator lights in communication with the controller and providing a visual indication of the dust readings.

14. A method of operating an air purifier including a housing having an air flow path therethrough and an air outlet, a motor mounted within the housing, a fan positioned within the air flow path driven by the motor, an air filter positioned within the air flow path, an air cowl having a peripheral edge, an air inlet defined between the peripheral edge and the housing, the method comprising the steps of:
a) mounting the air cowl to the housing such that the peripheral edge defines the air inlet with the housing;
b) positioning the air purifier within a room; and
c) actuating the motor to drive the fan and urge room air into the air inlet, through the air filter and out of the air outlet.

15. The method of operating the air purifier of claim 14 comprising the further steps of:
d) removing the air cowl from the housing;
e) removing the air filter from the housing;
f) inserting a replacement air filter into the housing; and
g) mounting the air cowl to the housing to secure the replacement air filter within the housing.

16. The method of operating an air purifier of claim 14 comprising the further steps of:
d) mounting a dust sensor to the housing, the dust sensor being in communication with a controller and the controller being in communication with the motor;
e) sampling the amount of dust within the room using the dust sensor;
f) transmitting a dust reading from the dust sensor to the controller; and
g) actuating the motor to operate at one of a high, medium and low speed based upon a signal from the controller depending upon the dust reading.

17. The method of operating an air purifier of claim 14 comprising the further steps of:
d) mounting an ionizer needle within the air flow path; and
e) actuating the ionizer needle to charge dust particles that flow through the air flow path when the air purifier is operating.

18. The method of operating an air purifier of claim 14 wherein the air cowl includes a bottom edge and a top edge, in step (b) an alignment arm proximate the bottom edge of the air cowl is positioned within an alignment indentation of the housing to align the air cowl relative to the housing, the air cowl is pivoted about the bottom edge such that the top edge moves toward the housing and a first magnetic member mounted on the housing is attracted to a second magnetic member mounted to the air cowl proximate the top edge to secure the air cowl to the housing.

19. The method of operating an air purifier of claim 14 comprising the further steps of:
d) removing the air cowl from the housing, thereby exposing the air filter; and
e) cleaning the air filter while the air filter is secured within the housing.

20. The method of operating an air purifier of claim 14 wherein the air cowl includes a plurality of spacers extending generally perpendicularly from an internal face, the spacers in engagement with the air filter in an assembled configuration to position the internal face a first distance from the air filter.
